(19) United States
(12) Patent Application Publication
(10) Pub. No.: US 2004/0226325 A1
(43) Pub. Date: Nov. 18, 2004

(54) Securing box

(76) Inventor: Renny Tse-Haw Ling, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/435,857

(22) Filed: May 12, 2003

(51) Int. Cl. E05B 65/52

(52) U.S. Cl. 70/63

(57) ABSTRACT

A securing box includes a box with a room defined therein, a cover pivotally connected to a side of the box to selectively close the room, a locking device mounted on the cover to switch between a locking status and an unlocking status, and an operation rod pivotally connected to the cover to limit movement of the cover relative to the box.

### BACKGROUND OF THE INVENTION

1. Field of the Invention

The present invention relates to a securing box, and more particularly to a securing box to receive therein valuable objects so that unauthorized personnel would not be able to have access to the objects received in the box.

2. Description of Related Art

With reference to FIGS. 1A and 1B, a conventional securing box is composed of a casing (A) with an opening and a door (A1) detachably connected to the casing (A) to cover the opening. The door (A1) has an extension (A3) extending out from a bottom of the door (A1) to correspond to a clamping flange (A4) formed on a distal edge defining the opening and a latch (A5) movably connected to a locking core (not numbered) on a rear side of the door (A1). It is noted that the latch (A5) is wedged so that after the extension (A3) is received in the opening and clamped by the clamping flange (A4), the door (A1) is able to use the wedged latch (A5) to slide in the opening and thus the wedged latch (A5) is clamped by the distal edge defining the opening. It is noted that a user is able to use the securing box to receive therein a key to a front door of a house where the user lives in so that the user only needs to remember the combination of the lock core, the user is able to have access to the key to open another door after the lock core is deactivated.

With reference to FIGS. 2A and 2B, another conventional securing box is shown. The conventional securing box of this kind has a casing (B), a door (B1) pivotally connected to a side of the casing (B) via a pin (B2) extending through a bottom face of the door (B1) and a wedged latch (B3) movably connected to a top face of the door (B1). Although the securing box has improvements over the securing box described in FIGS. 1A and 1B in that the door (B1) is always attached to the casing (B), the user needs not worry the door (B1) might become lost once the wedged latch (B3) is deactivated. However, because the door (B1) is pivotally connected to the casing (B) and the pin (B2) extends through the bottom face of the door (B1) and opposite sides of the casing (B), two distal ends of the pin (B2) are exposed to the air, unauthorized personnel is able to easily destroy the securing box by damaging the two exposed distal ends of the pin (B2) or simply cut off the wedged latch (B3) to disable the securing box. After the securing box is destroyed, the unauthorized personnel is able to have access to the valuable objects inside the casing (B). Besides, the locking core attached to the door is also exposed to the air. Moisture and dust in the air easily seep into the locking core to damage the mechanical relationships between parts of the locking core.

To overcome the shortcomings, the present invention tends to provide an improved securing box to mitigate and obviate the aforementioned problems.

### SUMMARY OF THE INVENTION

The primary objective of the present invention is to provide an improved

Another objective of the present invention is to provide an improved

Other objects, advantages and novel features of the invention will become more apparent from the following detailed description when taken in conjunction with the accompanying drawings.

### BRIEF DESCRIPTION OF THE DRAWINGS

FIGS. 1A and 1B are schematic views of a conventional securing box;

FIGS. 2A and 2B are schematic views of a conventional securing box;

FIG. 3 is a perspective view of a securing box of the present invention;

FIG. 4 is a cross sectional view of the securing box in FIG. 3;

FIG. 5 is an exploded perspective view of the securing box in FIG. 3;

FIG. 6 is a partial exploded perspective view of the securing box in FIG. 5

FIG. 7 is a cross sectional view taking from line I-I in FIG. 3;

FIG. 8 is a cross sectional view taking from line I-I in FIG. 3, which shows movement of the recovery spring;

FIG. 9 is a cross sectional view taking from line II-II in FIG. 4;

FIG. 10 is a schematic view showing that the operation rod is moved to a released position;

FIG. 11 is a schematic view showing another preferred embodiment to show that the box is secured on an object;

FIGS. 12A and 12B are schematic view showing the movement of the covering plate relative to the securing box; and

FIG. 13 is a schematic view showing that a seal is added to the window of the securing box.

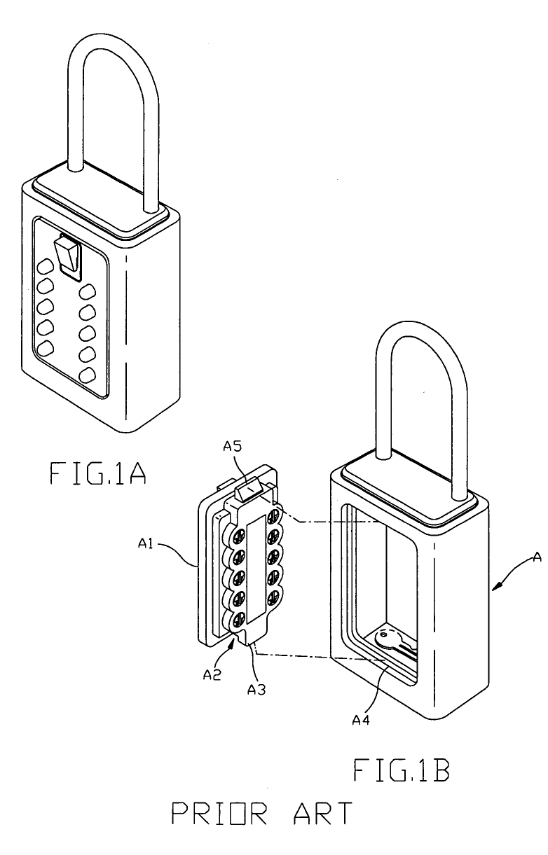

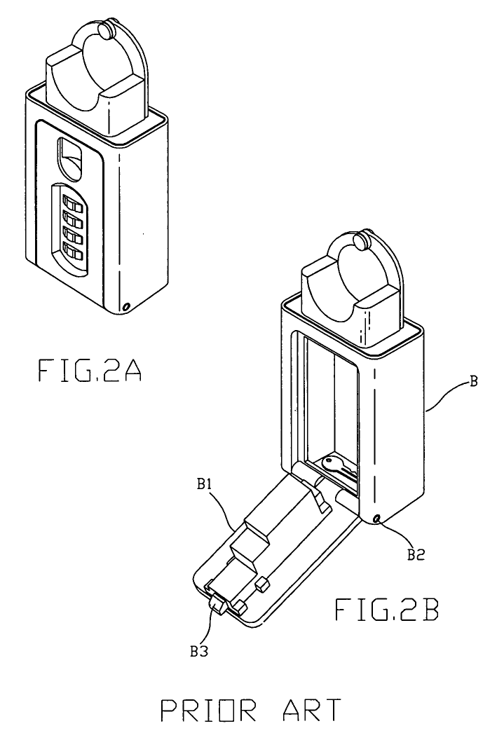

### DETAILED DESCRIPTION OF THE PREFERRED EMBODIMENT

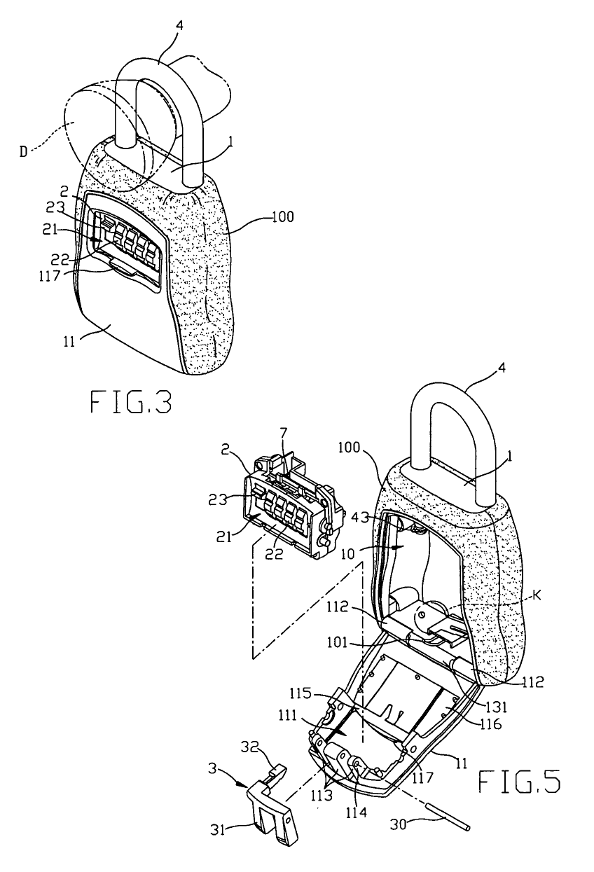

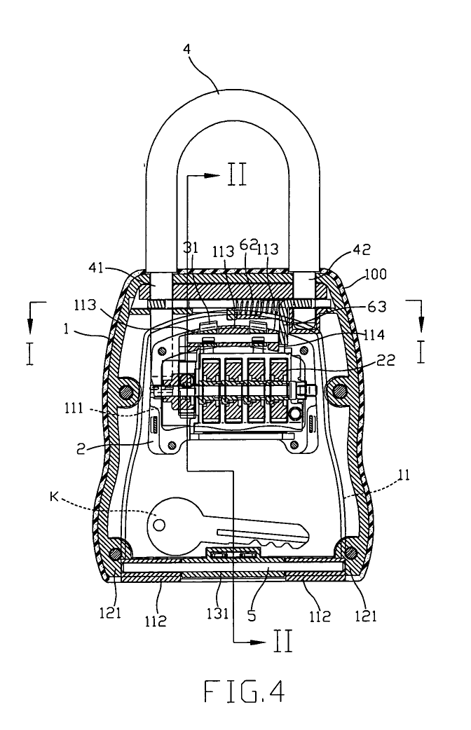

With reference to FIGS. 3 to 5, the securing box in accordance with the present invention includes a box (1) with a room (10) so as to receive within the room (10) an object such as a key (K), a cover (11) pivotally connected to a side face of the box (1) and having a window (111) defined in the cover (11), a locking device (2) mounted on the cover (11) to change between a locking status and an unlocking status, wherein the locking device (2) has an operation face (21) corresponding to the window (111) so that the operation face (21) is able to be exposed after assembly and an operation rod (3) pivotally connected to the cover (11) to secure the cover (11) to the box (1), wherein the operation rod (3) normally stays at a locked position. However, when the locking device (2) is at the unlocked status, the operation rod (3) is able to shift to an unlocked status such that the cover (11) is able to free open or close the box (1). The following is a detailed description of how the above mentioned parts interact to accomplish the foregoing object.

The box (1) has an elastic covering (100) to provide protection to the outer periphery of the box (1). The box (1) has a resilient element (101) mounted inside the box (1) to abut a face of the cover (11).

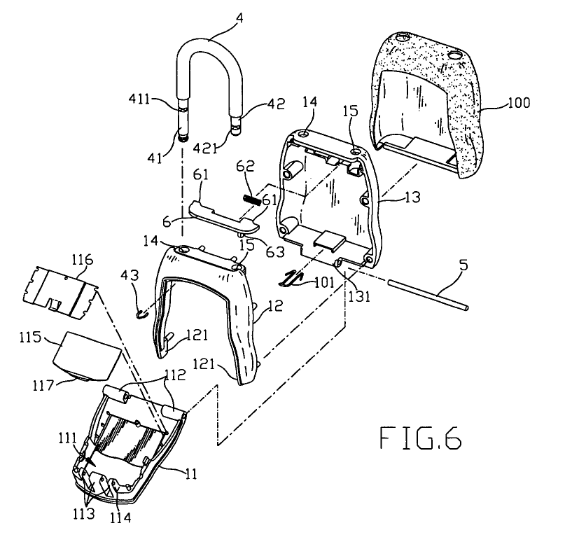

With reference to FIG. 6, the box (1) is composed of a front casing (12) and a rear casing (13) corresponding to the front casing (12) to combine into the box (1). The box (1) has two holes (14, 15) defined in a top face of the box (1) extending through top faces of each of the front and rear casing (12, 13) to respectively receive therein a long leg (41) and a short leg (42) of a hook (4). With such an arrangement, the hook (4) is able to securely attach to a suitable device such as the doorknob (D) in FIG. 3. The rear casing (13) has a pivot end. The pivot end has at least a first pivot ear (131) corresponding to at least a second pivot ear (112) formed on the cover (11). A shaft (5) is able to extend through the corresponding first pivot ear (131) and the second pivot ear (112) so that the cover (11) is able to pivot relative to the rear casing (13) of the box (1) about the shaft (5). After the combination between the cover (11) and the rear casing (13), the mounting of the front casing (12) on the rear casing (13) is able to cover two distal ends of the shaft (5) by two blocking ends (121) formed on opposite ends of the front casing (12) so that the two distal ends of the shaft (5) are concealed in the box (1).

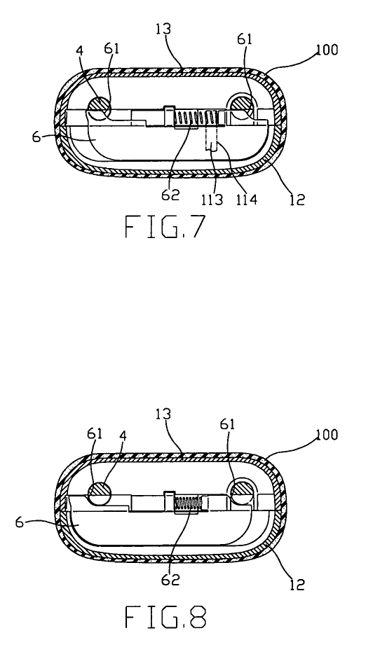

A ring (43) is provided on the long leg (41) of the hook (4) after the long leg (41) is inserted in one of the holes (14, 15) so that the long leg (41) is securely connected to the box (1). Each of the long leg (41) and the short leg (42) has an annular recess (411, 421) respectively to correspond to two retaining ends (61) of a retainer (6). The retainer (6) is urged by a first spring (62) so that the retainer (6) is maintained to engage with the hook (6) to have the retaining ends (61) received in the corresponding annular recesses (411, 421), which limits the movement of the hook (4), as shown in FIG. 7. The retainer (6) also has a push rod (63) integrally formed on the retainer (6) to control the movement of the retaining ends (61) and thus to release the limitation to the hook (4) when required, which is as shown in FIG. 8.

The locking device (2) may be but not limit to the type shown in the preferred embodiment. The locking device (2) has an operation face (21) provided on a front side of the locking device (2) to control the locking device (2) from a locking status to an unlocking status or vice versa. The operation face (21) of the locking device (2) shown in the preferred embodiment corresponds to the window (111) of the cover (11) so that a combination (22) of the operation face (21) is exposed for the user to operate. The operation face (21) also has an activation rod (23) movably mounted on the locking device (2) to operably connect to the operational rod (3) so that the operational rod (3) is able to be shifted by the activation rod (23) to the unlocked status to allow the cover (11) to pivot relative to the box (1).

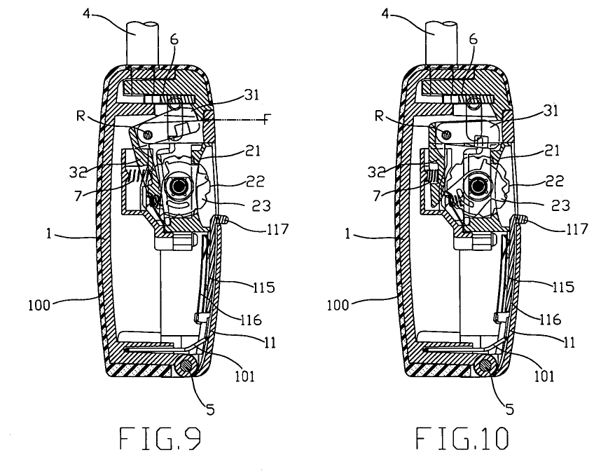

The cover (11) further has a seat (113) formed on the cover (11) to pivotally connect to a distal end of the operational rod (3) via a pivot rod (30), a clamping block (31) extending out from the operational rod (3) and a push rod (32) operably connected to the activation rod (23). Normally, a second resilient element (7) is provided to urge the operational rod (3) such that when the cover (11) closes the box (1), the clamping block (31) protrudes from a top face of the cover (11) to engage with a top face of the box (1) to secure the box (1), as shown in FIG. 9. When the locking device (2) is locked, the operational rod (3) can not be operated. Only when the locking device (2) is unlocked, can the operational rod (3) be operated by the activation rod (23) as shown in FIG. 10.

It is noted that the operational rod (3) is pivotally connected to the cover (1). When a force is employed trying to unlock the cover (11), the operational rod (3) will pivot to the locked status. That is, when a force F is applied from a joint between the cover (11) and the box (1), the operational rod (3) will pivot about a center R. Therefore, when the operational rod (3) does pivot, a blocking plate (114) formed adjacent to the seat (113) stops the movement of the push rod (63) so that the hook (4) is secured to, for example, the doorknob (D).

With reference to FIG. 11, another preferred embodiment of the securing box of the present invention with the hook (4) and the retainer (6) removed.

When the securing box is required to be mounted on a wall, holes (102) are defined in a side face of the box (10) such that screws (8) are able to extend through the holes (102) to mount the box (10) on the wall.

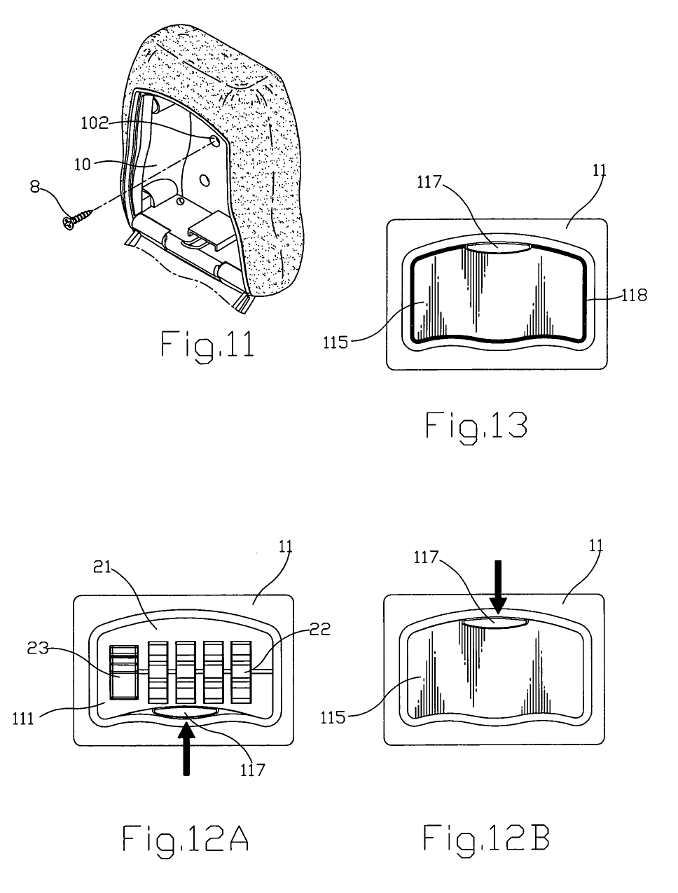

In summary of the present invention, the securing box has concealed shaft (5), innovative operational rod (3) and also the protection to the operation face, which is as shown in FIG. 5. A protection cover (115) is slidably mounted on the cover (11) to selectively cover the window (111) of the cover (11). The protection cover (115) has an engagement plate (116) formed on a side face of the protection cover (115) to allow the protection cover (115) to be slidably mounted on the cover (11). The protection cover (115) has an open end (117) to allow the user to maneuver the protection cover (115) so that whether the operation face (21) of the locking device (2) is concealed or exposed is determined by the movement of the protection cover (115), as shown in FIGS. 12A and 12B.

In order to provide a waterproof protection effect to the securing box, a seal (118) is provided on an outer periphery of the protection cover (115) as shown in FIG. 13.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A securing box comprising:
a box with a room defined therein;
a cover pivotally connected to a side of the box to selectively close the room;
a locking device mounted on the cover to switch between a locking status and an unlocking status; and
an operation rod pivotally connected to the cover to limit movement of the cover relative to the box, thereby allowing the operation rod to move to a direction to close the box when a force is exerted on the operation rod trying to open the cover.

2. The securing box as claimed in claim 1, wherein the box comprises:
a rear casing to define therein a pivot end and at least a first pivot ear formed on the pivot end, wherein the cover has at least a second pivot ear corresponding to the at least one first pivot ear so that a shaft is able to extend through the corresponding at least one first pivot ear and the at least one second pivot ear to allow the cover to pivot about the shaft, and
a front casing mounted on top of the rear casing and having two blocking ends to conceal two distal ends of the shaft after extending through the at least one first pivot ear and the at least one second pivot ear.

3. The securing box as claimed in claim 1 further comprising a hook with a long leg and a short leg, wherein the long leg is secured to the box and the short leg is selectively connected to the box.

4. The securing box as claimed in claim 3 further comprising a retainer urged by a resilient element to limit movement of the long leg and the short leg of the hook and having a push rod allowing the retainer to be moved to release limitation to the hook.

5. The securing box as claimed in claim 4, wherein the cover has a blocking plate formed on the cover so that when the cover closes the room, the blocking plate limits movement of the push rod of the retainer and the hook is secured.

6. The securing box as claimed in claim 1, wherein holes are defined in a side face of the box to allow the securing box to be positioned on an object.

7. The securing box as claimed in claim 1, wherein an elastic covering is added to an outer periphery of the cover.

8. A securing box comprising:
a box with a room defined therein;
a cover pivotally connected to a side of the box to selectively close the room, the cover having a window formed therethrough;
a locking device mounted on the cover to switch between a locking status and an unlocking status, the locking device has an operation face disposed in aligned relationship with the window;
an engagement plate coupled to the cover adjacent the window, the engagement plate being spaced from an inner surface of the cover; and
a protection cover slidably connected to the cover to be selectively displaceable from the space between the engagement plate and the inner surface to a position between the window and the operation face of the locking device.

9. (Cancelled).

10. The securing box as claimed in claim 8, wherein a seal is disposed along a perimeter edge of the protection cover.

11. The securing box as claimed in claim 10, wherein an open end portion is formed on the protection cover to function as a handle and allow the protection cover to be maneuvered so that whether the operation face of the locking device is concealed or exposed is determined by movement of the protection cover.
